(19) United States
(12) Patent Application Publication
(10) Pub. No.: US 2026/0203590 A1
(43) Pub. Date: Jul. 16, 2026

(54) TRANSFERABLE META-LEARNING PROCESS FOR MACHINE LEARNING

(71) Applicant: International Business Machines Corporation, Armonk, NY (US)

(72) Inventors: Xinying Qu, Weatogue, CT (US); Parikshit Ram, SANDY SPRINGS, GA (US); Horst Cornelius Samulowitz, YORKTOWN HEIGHTS, NY (US); Udayan Khurana, YORKTOWN HEIGHTS, NY (US)

(21) Appl. No.: 19/023,052

(22) Filed: Jan. 15, 2025

(51) Int. Cl. G06N 3/0895; G06N 3/0455

(52) U.S. Cl. CPC G06N 3/0895; G06N 3/0455

(57) ABSTRACT

An example operation includes one or more of receiving a first data set comprising a combination of labeled data and unlabeled data, extracting features from the first data set based on execution of a feature extractor on the labeled data and the unlabeled data, and pre-training a machine learning (ML) model based on execution of the ML model on the extracted features to generate a pre-trained ML model, wherein the pre-training comprises executing a feature encoder of the ML model on the extracted features to generate embeddings, executing a decoder of the ML model on the embeddings to generate reconstructed features, and executing a prediction head of the ML model on the embeddings to generate predicted outputs, and wherein the pre-training further comprises modifying parameters of the feature encoder, parameters of the decoder, and parameters of the prediction head.

### BACKGROUND

Traditional machine learning processes build and train a new model for each new task, based on available labeled data. Meanwhile, transfer learning algorithms utilize already-trained machine learning models as a starting point and apply the model's existing knowledge to a new, related target task. The present invention relates to transfer learning and to machine learning that is applied to tabular data.

### SUMMARY

One example embodiment provides a method that may include one or more of receiving a first data set comprising a combination of labeled data and unlabeled data, extracting features from the first data set based on execution of a feature extractor on the labeled data and the unlabeled data, and pre-training a machine learning (ML) model based on execution of the ML model on the extracted features to generate a pre-trained ML model, wherein the pre-training comprises executing a feature encoder of the ML model on the extracted features to generate embeddings, executing a decoder of the ML model on the embeddings to generate reconstructed features, and executing a prediction head of the ML model on the embeddings to generate predicted outputs, and wherein the pre-training further comprises modifying parameters of the feature encoder, parameters of the decoder, and parameters of the prediction head.

Another example embodiment provides a computer system that may include a processor set, one or more computer-readable storage media, and program instructions stored on the one or more computer-readable storage media to cause the processor set to perform operations that may include one or more of receiving a first data set comprising a combination of labeled data and unlabeled data, extracting features from the first data set based on execution of a feature extractor on the labeled data and the unlabeled data, and pre-training a machine learning (ML) model based on execution of the ML model on the extracted features to generate a pre-trained ML model, wherein the pre-training comprises executing a feature encoder of the ML model on the extracted features to generate embeddings, executing a decoder of the ML model on the embeddings to generate reconstructed features, and executing a prediction head of the ML model on the embeddings to generate predicted outputs, and wherein the pre-training further comprises modifying parameters of the feature encoder, parameters of the decoder, and parameters of the prediction head.

A further example embodiment provides a computer program product that may include one or more computer-readable storage media, and program instructions stored on the one or more computer-readable storage media to perform operations that may include one of more of receiving a first data set comprising a combination of labeled data and unlabeled data, extracting features from the first data set based on execution of a feature extractor on the labeled data and the unlabeled data, and pre-training a machine learning (ML) model based on execution of the ML model on the extracted features to generate a pre-trained ML model, wherein the pre-training comprises executing a feature encoder of the ML model on the extracted features to generate embeddings, executing a decoder of the ML model on the embeddings to generate reconstructed features, and executing a prediction head of the ML model on the embeddings to generate predicted outputs, and wherein the pre-training further comprises modifying parameters of the feature encoder, parameters of the decoder, and parameters of the prediction head.

### BRIEF DESCRIPTION OF THE DRAWINGS

FIG. 1 is a diagram illustrating a computing environment according to an embodiment of the instant solution.

FIG. 2A is a diagram illustrating a process of pre-training a machine learning model according to examples and features of the instant solution.

FIG. 2B is a diagram illustrating a process of fine-tuning a pre-trained machine learning model according to examples and features of the instant solution.

FIG. 3A is a diagram illustrating a process of extracting meta-features from a data set according to examples and features of the instant solution.

FIG. 3B is a diagram illustrating a process of embedding features through an encoder according to examples and features of the instant solution.

FIG. 3C is a diagram illustrating a process of generating a prediction loss and a reconstruction loss according to examples and features of the instant solution.

FIG. 3D is a diagram illustrating an example of an encoder and a decoder according to examples and features of the instant solution.

FIG. 4A is a flow diagram illustrating a method according to examples and features of the instant solution.

FIG. 4B is a flow diagram illustrating a method according to additional examples and features of the instant solution.

FIG. 4C is a flow diagram illustrating another method according to additional examples and features of the instant solution.

FIG. 5A is a system diagram illustrating integration of an AI model into any decision point according to the examples and features of the instant solution.

FIG. 5B is a diagram illustrating a process for developing an AI model that supports AI-assisted computer decision points according to the examples and features of the instant solution.

FIG. 5C is a diagram illustrating a process for utilizing an AI model that supports AI-assisted computer decision points according to examples and features of the instant solution.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

Traditional machine learning/training processes build a new model for each new task, based on available labeled data. This is often because traditional machine learning algorithms assume training and test data come from the same feature space. Meanwhile, if the data distribution changes, or the trained model is applied to a new dataset (or data set), users must retrain a newer model from scratch, even if attempting a task similar to that of the first model. Transfer learning algorithms, however, can utilize already-trained models as a starting point, and apply the model's knowledge gained in an initial source task or data (e.g., classifying movie reviews) toward a new, yet related, target task or data (e.g., classifying song reviews).

Transfer learning reduces the requisite computational costs to build models for new problems. In particular, transfer learning can repurpose a pre-trained machine learning model to perform a different prediction task. Thus, transfer learning can reduce the amount of model training time, training data, processor units, and other computational resources. For instance, a fewer number of epochs (e.g., passes through a data set, etc.) may be needed to achieve a desired learning rate. In this way, transfer learning can accelerate and simplify model training processes. Transfer learning particularly helps alleviate difficulties involved in acquiring large datasets. For instance, large language models (LLMs) require large amounts of training data to obtain optimal performance. High-quality publicly available data sets can be limited, and producing sufficient manually labeled data can be time-consuming and expensive.

While transfer learning aids model optimization, it can further increase a model's generalizability. Because transfer learning involves fine-tuning (also referred to herein as re-training) an existing model with a new data set, the retrained model will consist of knowledge gained from multiple data sets. It may display better performance on a wider variety of data than the initial base model trained on a single type of dataset. Transfer learning can thus inhibit overfitting.

The example embodiments are directed towards a pre-training process for a machine learning model, specifically targeting tabular data. For example, the system described herein may be used to develop a foundational model that supports transfer learning. This process involves training a model on a variety of datasets, enabling it to build generalized knowledge that can be fine-tuned for specific downstream tasks (e.g., classification or prediction for individual datasets). This saves time and computational resources compared to training a new model from scratch for each task. Tabular data refers to data organized into a table with one or more rows and one or more columns. For example, each row represents an observation, value, and/or example and each column represents an attribute. Tabular representation of data in many instances makes the data easier to read and to understand and enables easier analysis of large amounts of data. The data is organized systematically and typically allows for efficient comparison and statistical analysis.

During training, the process may train the machine learning model using both labeled and unlabeled data, in comparison to traditional mechanisms which only used either labeled data or unlabeled data. That is, both labeled and unlabeled data can be used, thereby enabling the model to learn a wider range of patterns. For example, for downstream prediction tasks where labeled data is limited, users can potentially improve the prediction performance by simply incorporating more unlabeled data. These unlabeled data points can still contribute to the model's understanding of the underlying distributions of the data points and patterns within the data set.

Transfer learning is a machine learning technique in which a model that has been trained on one task is reused and adapted to solve a different task. Instead of starting from scratch and training a new model for every task, transfer learning allows a pre-trained model to leverage patterns and knowledge gained from the initial task, which can improve performance and reduce the amount of data and training time needed for the new task. This is often achieved through a process called fine-tuning. Fine-tuning involves taking a pre-trained model, typically trained on a large, generalized data set, and further training it on a smaller, task-specific dataset to improve its performance on the new task. For instance, a model trained on a large, generalized tabular dataset, such as customer demographics and purchasing behavior across multiple industries, could be fine-tuned on a dataset that focuses on customer behavior for a specific company. This fine-tuning enables the model to specialize in the task at hand, improving its ability to make accurate predictions for the new dataset while retaining the useful patterns it learned from the original task. By using transfer learning and fine-tuning, models can be efficiently adapted to different tasks, making them more versatile and effective at solving a wide range of problems.

Some of the benefits created by the system described herein include a machine learning (ML) model that is pre-trained with a greater depth of knowledge by training the ML model on multiple datasets rather than a single dataset. This generalization enables the ML model to perform effectively on unseen datasets through fine-tuning. Another benefit is that fine-tuning the pre-trained model can achieve comparable or even better performance on certain data sets compared to traditional models such as Logistic Regression or XGBoost. Such improvements are the result of the model's ability to leverage cross-dataset knowledge learned during pre-training. Another benefit is that the ML model is particularly valuable for few-shot learning scenarios, where only limited data is available. Fine-tuning the pre-trained model can reduce the need for large datasets, and enable it to perform well with minimal data such as few-shot scenarios.

One or more of the present embodiments combine traditional machine learning and deep learning in the process of learning the data representation. Traditional machine learning, in terms of multiple supervised and unsupervised learning algorithms, is used to extract meaningful meta-features from the raw input features. Deep learning, in terms of a deep neural network, is then used to draw the relationship between the meaningful meta-features and the true label of a data point. Second, unlabeled data in addition to the labeled data is utilized in learning the representation of a tabular dataset. Given that unlabeled data widely exists in real life and is relatively inexpensive to collect compared to the labeled ones, one or more of the disclosed embodiments are able to leverage a much larger number of data points to learn the data representation, specifically through the adoption of unsupervised learning algorithms, such as PCA. Third, one or more of the present embodiments uses a combination of supervised, unsupervised, and self-supervised learning to provide trainable feature embedding that potentially enhances the prediction performance. As stated previously, meaningful features are extracted using both supervised and unsupervised algorithms. The extracted meta-features are subsequently passed through an auto-encoder during the pre-training phase to provide trainable feature embedding that minimizes the sum of the reconstruction loss and the prediction loss. The prediction loss is minimized through supervised learning, whereas the reconstruction loss is minimized through self-supervised learning. Last, being pre-trained on a broad range of datasets, one or more of the present embodiments enables transfer learning among domain-agnostic tabular datasets. Applying the pre-trained model to different downstream tasks, the present embodiments are able to achieve comparable performance as a gradient-boosted tree algorithm on most of the datasets regardless of the data domain and size.

The learning system described herein may be integrated within a software application, a service, or the like, which may be hosted by a host platform such as a cloud platform, a web server, a database, or the like.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Thus, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

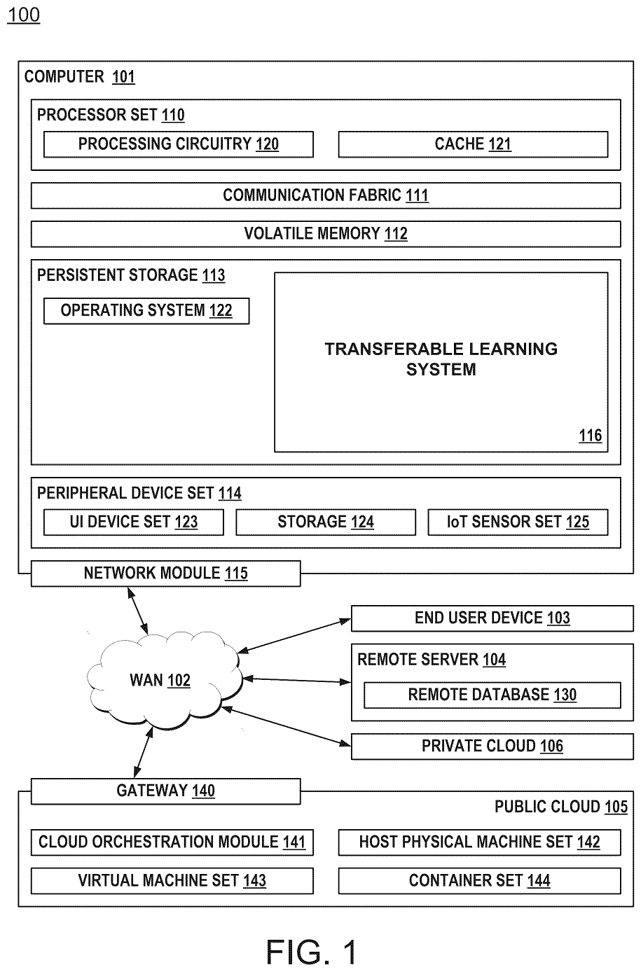

FIG. 1 illustrates a computing environment 100 according to an embodiment of the instant solution. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 1, computing environment 100 contains an example of an environment for executing at least some of the computer code involved in performing the inventive methods, such as transferable learning system 116. In addition to block 116, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 116, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically the computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 116 in persistent storage 113.

COMMUNICATION FABRIC 111 is the signal conduction path that allows the various components of computer 101 to communicate with each other. Typically, this fabric comprises switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 116 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth® connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi® signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi® network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

CLOUD COMPUTING SERVICES AND/OR MICROSERVICES (not separately shown in FIG. 1) private and public clouds are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The system described herein provides a comprehensive framework and approach for pre-training and fine-tuning foundational models for tabular data. It draws on the concept of knowledge transfer between tabular prediction tasks. By leveraging transfer learning, it enables effective learning across different tasks. Additionally, while the description herein may focus on binary classification data sets, the approach can be expanded to accommodate various types of prediction tasks, including multi-classification tasks and regression tasks. In addition, the system supports user customization of the models through parameter selection.

The system is available as a software library which can be integrated into a software application or other software program. Users can download the repository and import the library into their own projects to use it. This approach allows users to run the model locally or on their own infrastructure.

Foundation models for tabular data are under-explored due to a number of challenges, such as heterogeneous feature types and feature importance, arbitrary order of columns, sparsity of categorical features, and the domain-specificity of different datasets (e.g., financial data versus medical data). While it is challenging to develop a foundation model for tabular data, the exploration of effective learning approaches for tabular data has important implications.

The system described herein provides a novel meta-learning approach for tabular data. The system imposes few restrictions on its input data, allowing for its broad application to downstream tasks across any domains and with varying feature types (e.g., numerical features, categorical features, a mix of numerical and categorical features, and features with missing values). Further, to learn the data representation, the system incorporates a number of traditional supervised and unsupervised machine learning algorithms to convert the raw input features into meaningful meta-features. Through the use of unsupervised learning, the system is able to utilize unlabeled data points, which widely exist in real-life datasets, in addition to the labeled ones, to learn the data representation. In addition, the system leverages deep learning, with the use of both supervised and self-supervised learning, to further transform the meta-features into enhanced feature embedding. Further, the system is pre-trained over a broad range of datasets from different domains and can be applied to domain-agnostic downstream tasks through a relatively inexpensive process of fine-tuning. Comparing the performance of the ML model trained by the system against baseline models on downstream classification tasks, the trained ML model matches or improves upon the performance of gradient-boosted tree algorithms without the need for training the task-specific process from scratch.

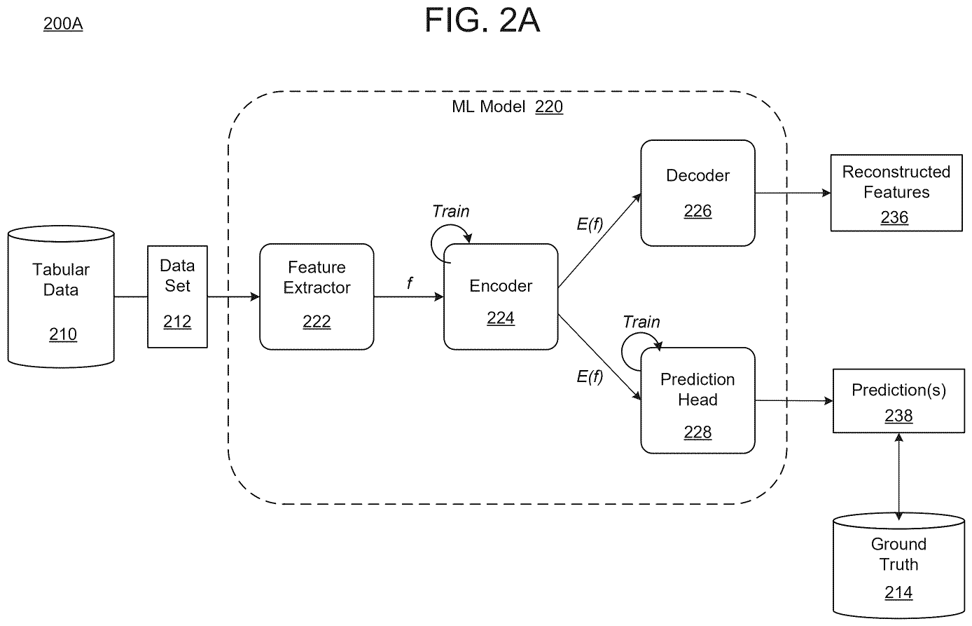

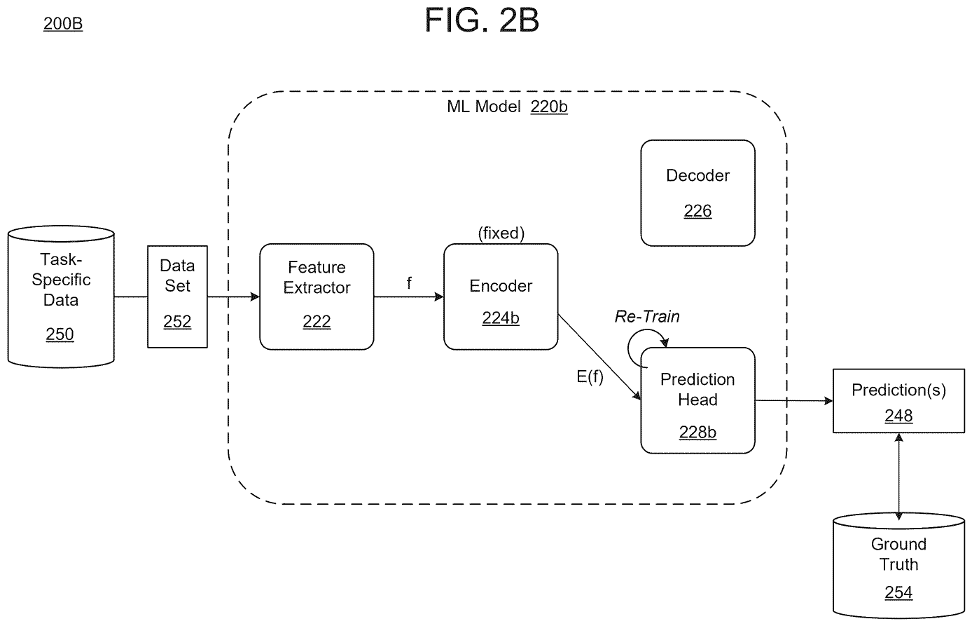

FIG. 2A illustrates a process 200A of pre-training a machine learning model 220 according to examples and features of the instant solution. Referring to FIG. 2A, the machine learning model 220 described herein includes a feature extractor 222, an encoder 224, a decoder 226, and a prediction head 228. The feature extractor 222 is responsible for extracting features (the extracted features are referred to herein as meta-features, etc.) from a data set 212, such as tabular data 210 stored in a database. The encoder 224 is responsible for embedding the extracted features into an embedding space (e.g., vector space).

The decoder 226 is responsible for reconstructing the features from the encoded features to generate reconstructed features 236. The reconstructed features 236 can be compared to the features extracted by the feature extractor 222 to determine a reconstruction loss during the pre-training phase to train the encoder 224. Meanwhile, the prediction head 228 is responsible for generating a predicted output (predictions 238). The predictions 238 can be compared to ground truth data 214 to determine a prediction loss which can be used to train the prediction head 228, in addition to the encoder 224. For example, the prediction loss can be used to simultaneously train the prediction head 228 and the encoder 224.

The machine learning model 220 allows for a pre-training of the encoder 224 and the prediction head 228 by transforming raw data into meaningful representations and generating a prediction loss. Meanwhile, the decoder 226 reconstructs input data during pre-training and operates independently of the prediction head 228. The prediction head 228 generates final predictions for specific tasks, and is independent of the decoder 226.

The decoder 226 is responsible for reconstructing the input data from encoded meta-features. This reconstruction helps the network learn the essential characteristics of the data through self-supervised learning. The better the decoder 226 is at reconstructing the original data (as measured by a low reconstruction loss), the more effectively the machine learning model 220 captures meaningful patterns and preserves important information in the latent representation. Without this step, the machine learning model 220 would not have a way to validate whether it is learning relevant features during pre-training. During pre-training, the MLP (multi-layer perceptron) of the prediction head 228 is used to minimize the prediction loss through supervised learning. The decoder 226, on the other hand, works to minimize reconstruction loss through self-supervised learning. The total loss during the pre-training process is a weighted sum of the reconstruction loss and the prediction loss. The reconstruction loss is used to affect the parameters in the encoder 224 and the decoder 226. The prediction loss is used to affect the parameters in the encoder 224 and the prediction head 228. This effect is because, to make accurate predictions, the encoder 224 needs to generate a latent representation that is not only useful for reconstruction but also contains relevant features for predictions. During pre-training, gradient updates are applied to the encoder 224, decoder 226, and prediction head 228. The encoder 224 is influenced by both losses, whereas the decoder 226 only learns based on the reconstruction loss. The prediction head 228 is updated solely from the prediction loss.

FIG. 2B illustrates a process 200B of fine-tuning the pre-trained machine learning model generated by the process shown in FIG. 2A, according to examples and features of the instant solution. According to various embodiments, the machine learning model 220 shown in FIG. 2A is “pre-trained” based on the training process shown in FIG. 2A to generate a pre-trained ML model 220b. In particular, in the pre-training the encoder 224 is trained based on the reconstruction loss to generate a pre-trained encoder 224b while the prediction head 228 is trained based on the prediction loss to generate a pre-trained prediction head 228b.

Referring now to FIG. 2B, the pre-trained ML model 220b is retrained/fine-tuned to further improve the accuracy of the pre-trained ML model 220b for a target task. During the fine-tuning phase, the parameters of the pre-trained encoder 224b are fixed. Here, the pre-trained encoder 224b acts as a foundation that speeds up the learning process for new tasks. Instead of building a new model from scratch, the fine-tuning allows the pre-trained ML model 220b to transfer knowledge from the pre-training phase to the new task. This transfer may increase efficiency and lead to better prediction performance.

For example, a data set 252 corresponding to a target-specific task may be obtained from a task-specific database 250 and used to retrain the pre-trained ML model 220b, and in particular, the pre-trained prediction head 228b. Here, the feature extractor 222 extracts meta-features from the data set 252 and inputs those extracted meta-features into the pre-trained encoder 224b. The pre-trained encoder 224b, in response, embeds the meta-features into an embedding space. The decoder 226 is not used during the fine-tuning phase because the pre-trained encoder 224b is not being modified. Instead, the pre-trained prediction head 228b generates outputs (predictions 248) from the embedded features. The process compares the predictions 248 to additional ground truth data 254 to generate an additional prediction loss which may be used to retrain the pre-trained prediction head 228b for a specific task. In some embodiments, the pre-trained ML model 220b may exist without the decoder 226, so that in between the pre-training stage (FIG. 2A) and the fine-tuning stage (FIG. 2B) the decoder is discarded or removed from the other components of the pre-trained ML model 220b.

The pre-trained prediction head 228b in the fine-tuning phase works together with the pre-trained encoder 224b to generate predictions for the new task. The pre-trained encoder 224b provides the learned representations, and the pre-trained prediction head 228b further processes them to make predictions. The predictions are analyzed to determine the prediction loss as part of the fine-tuning. Parameters of the pre-trained prediction head 228b are adjusted/optimized to minimize the prediction loss to perform the fine-tuning. Without the pre-trained prediction head 228b, the encoded features would not be effectively transformed into outputs for the specific prediction task.

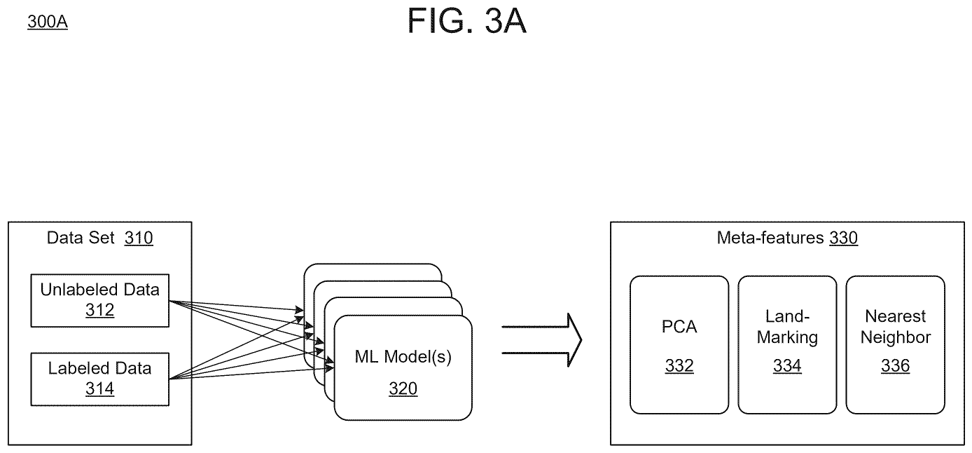

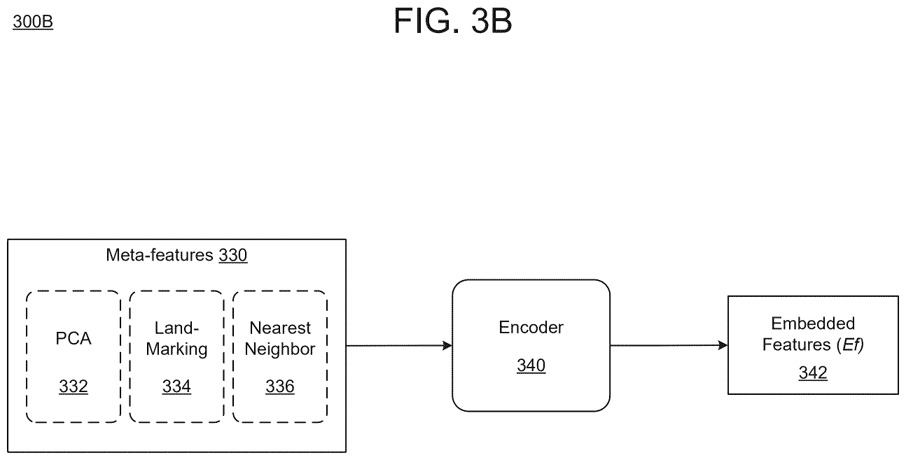

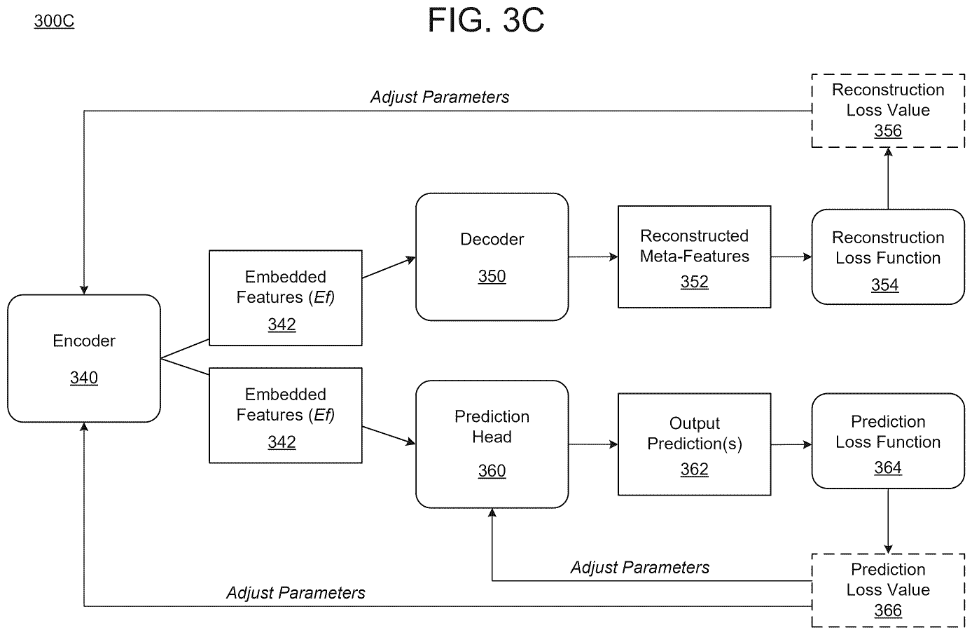

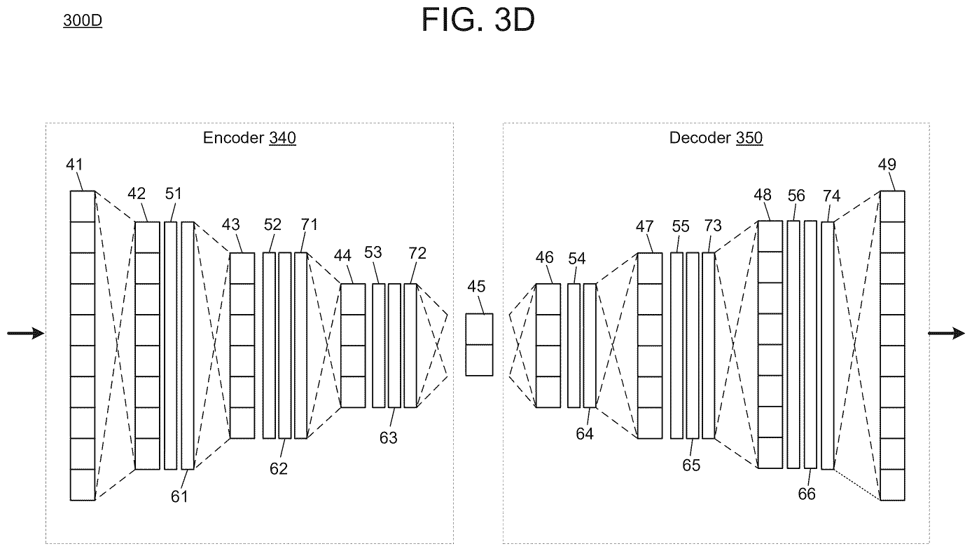

FIG. 3A illustrates a process 300A of extracting meta-features from a data set 310 according to examples and features of the instant solution. For example, the process 300A may be performed by the feature extractor 222 that is described with respect to FIGS. 2A and 2B. Referring to FIG. 3A, the data set 310 may include a binary classification data set. Binary classification datasets are those with labels representing two distinct categories (e.g., predicting whether a credit application is approved or denied). As another example, the ML model described herein can handle various data set types, including types related to multi-class classification and regression tasks. The architecture of the system described herein is not restricted to performing binary tasks, and it can generalize and extend to other types of prediction problems.

In this example, the data set 310 includes unlabeled data 312 and labeled data 314. Here, the labeled data 314 has tags or labels that classify the data outcomes while the unlabeled data 312 does not contain such tags or labels. For example, the labeled data 314 may include tags that specify whether the data belongs to a first type or a second type. In this example, the ML model can be trained to predict whether the input data is of the first type or the second type. During the meta-feature extraction process, the labeled data is used to train a series of supervised ML models, such as a logistic regression model, a random forest model, and a nearest neighbors model. Both unlabeled data 312 and labeled data 314 are used to train unsupervised ML models, such as one that implements Principal Component Analysis (PCA). The fitted ML models are then applied to transform the input features into a consistent set of meta-features. This meta-feature extraction process allows for tabular datasets with any number of columns (i.e., features) to be converted into a standard format with a fixed set of meta-features. This process can be useful because only when the input datasets have the same number of columns (i.e., features) can they be processed by the encoder for pre-training. The process essentially enables the neural network to learn underlying patterns across various datasets by identifying data characteristics represented by these meta-features. These meta-features provide a common foundation upon which the model's transfer learning capabilities are built. In transfer learning, the patterns learned during pre-training can be effectively applied to new datasets, by leveraging the shared structure captured through the meta-features.

According to various embodiments, the data set 310 may be passed through one or more ML models 320, which are part of the feature extractor, and which can extract meta-features 330 from the data set 310. For example, meta-features refer to higher-level features derived from the original input features, inspired by the concept of “meta-learning.” Meta-learning refers to the ability of a model to be trained not only to solve a specific task but also to improve its own learning process over time by adapting to new tasks based on past experiences. These meta-features are uniform features that are consistent in number across different datasets. These meta-features help the model capture underlying patterns and relationships in a dataset.

During meta-feature extraction, the system uses supervised ML models to extract features from labeled data and utilizes unsupervised ML models to extract features from unlabeled data. Through the process of leveraging both labeled and unlabeled data using different ML models for feature extraction, the system can then introduce the specific supervised models (e.g., logistic regression, nearest neighbor) and unsupervised models (e.g., PCA) as well as the meta-features that they generate. The supervised ML models and the unsupervised ML models are able to generate meaningful sets of meta-features for any dataset. The patterns learned from the meta-features essentially provide the foundation for transfer learning in the example embodiments.

In the example embodiments, labeled data and unlabeled data can both be utilized to transform data sets with a standard set of meta-features. For example, the system may train one or more supervised ML models using labeled data while training one or more unsupervised ML models using a combination of labeled data and unlabeled data. The one or more trained unsupervised ML models can be used to extract meta-features from the data set 310 such as principal component analysis (PCA) meta-features 332 which summarize the data set 310 by capturing the maximum variance, with each principal component (PC) representing a combination of original features. In addition, the one or more trained supervised ML models can be used to extract meta-features from the data set 310 such as landmarking meta-features 334, which indicate how well simple machine learning models (e.g., logistic regression, decision trees, k-nearest neighbors) perform and such as nearest neighbor meta-features 336, which measure the similarity between data points and help the model understand clustering tendencies within the data.

As an example, the feature extractor may generate the PCA meta-features 332 using a second half of labeled rows in the labeled data 314 using two approaches. In the first approach, an ML model is fitted with the first half of the rows from the labeled data 314 and all the rows from the unlabeled data 312. In the second approach, a PCA model is fitted with the first half of the rows from the labeled data 314 only. In both approaches, the fitted PCA model will then be used to transform the second half of the rows from the labeled data 314 into a number of PCA meta-features.

As another example, the feature extractor may generate the landmarking meta-features 334 for the rows of the second half of the labeled data 314 by fitting several supervised machine learning models with the first half of the rows from the labeled data 314. The fitted models are then used to predict the probability of each unique class for every row. The predicted probabilities will be included as the landmarking meta-features 334. The supervised machine learning models for generating the landmarking meta-features 334 may include one or more of Logistic Regression, Gaussian Naïve Bayes, Extra Trees Classifier, Random Forest Classifier, XGBoost Classifier, and MLP Classifier by default.

As another example, for a given row in the second half of the labeled data 314, the meta-features of its nearest neighbors selected from the first half of the labeled data 314 are included in the focal row's meta-features. Since the true labels of the rows from the labeled data 314 are known, neighbors from each unique class are selected with an equal number (e.g., 10 neighbors from class 1 and 10 neighbors from class 0). In addition, a focal row's meta-features will also include the Euclidean distance between this row and all its selected neighbors, based on the scaled pre-processed input features (pre-processing of input features includes missing value imputation and one-hot encoding of the categorical features).

FIG. 3B illustrates a process 300B of embedding features through an encoder according to examples and features of the instant solution. For example, the process 300B shown in FIG. 3B may be performed by an encoder 340 which may correspond to either the encoder 224 or the pre-trained encoder 224 b. Referring to FIG. 3B, the encoder 340 converts the meta-features 330 into embedded features 342 in an embedding space (e.g., vector space, etc.). Here, the encoder 340 goes beyond simply converting raw meta-features into vector representations. It learns how to represent these features in a data-dependent, task-relevant manner during pre-training. Specifically, during the embedding process, the encoder identifies the representation of features in a way that reflects the underlying structure of the data as well as the specific objectives of the prediction tasks. By learning which data patterns and interactions are most important for the task, the encoder ensures that the encoded features not only represent the data effectively but are also aligned with the prediction problem's goals. By focusing on task-specific aspects of the data, this step makes the model more effective when fine-tuned for specific prediction tasks.

The feature embedding process transforms complex input data into numerical vectors, enabling the model to learn patterns more easily. Training the model involves adjusting the embeddings to capture the essential relationships between data points. The process of embedding ensures that the model can generalize and make accurate predictions.

FIG. 3C illustrates a process 300C of generating a prediction loss value 366 and a reconstruction loss value 356 according to examples and features of the instant solution. Referring to FIG. 3C, the embedded features 342 generated by the encoder 340, such as described in the example of FIG. 3B, may be input into a decoder 350 and simultaneously to a prediction head 360. Here, the decoder 350 and the prediction head 360 may operate independently and in parallel, on the embedded features 342. For example, a first processing core may execute the decoder 350 while a second processing core may execute the prediction head 360, but embodiments are not limited thereto.

In this example, the decoder 350 reconstructs the meta-features from the embedded features 342 to generate reconstructed meta-features 352. Meanwhile, the prediction head 360 processes the embedded features 342 to generate a predicted output 362. The prediction head 360 is the component of the model responsible for generating the final predictions. It takes the encoded features as input and processes them to produce the output (e.g., classification or regression results). Unlike the feature extractor and encoder, which focus on data transformation, the prediction head 360 is designed to generate task-specific predictions.

The software may use a reconstruction loss function 354 to determine the reconstruction loss value 356 based on a comparison of the reconstructed meta-features 352 and the original meta-features 330 (shown in FIG. 3A). The reconstruction loss value 356 may be used by the software to adjust or fine-tune the parameters/hyperparameters of the encoder 340 to train the encoder 340. This process may be iteratively performed. In addition, the software may use a prediction loss function 364 to determine the prediction loss value 366 of the prediction head 360, and use the prediction loss value 366 to adjust or fine-tune the parameters/hyperparameters of both the encoder 340 and the prediction head 360.

The system may consider two types of loss for the pre-training phase: reconstruction loss and prediction loss. Reconstruction loss refers to the loss function used to train the auto-encoder. In at least some embodiments, the reconstruction loss is measured by the mean square error (MSE) between the input data of the encoder (i.e., the meta-features) and the reconstructed data output by the decoder (i.e., the reconstructed meta-features). In at least some embodiments, the reconstruction loss has a weight of alpha in the total loss function. The reconstruction loss affects the parameters in the encoder 340 and the decoder 350. In at least some embodiments, prediction loss is measured by cross entropy, given that the pre-training task is classification. The prediction loss affects the parameters in both the encoder 340 and the prediction head 360. This is because, to make accurate predictions, the encoder 340 needs to generate a latent representation that is not only useful for reconstruction but also contains relevant features for predictions. The combined loss function appears in at least some embodiments as:

L_{pre-training}=α×L_{reconstruction}+L_{prediction}

In at least some embodiments, α is set to 1 and is reduced by a set amount, e.g., 0.1, for every certain number of epochs that is run, e.g., for every 20 epochs. In at least some embodiments, an adaptive moment estimation optimizer (Adam optimizer) is set as the default optimizer, with an initial learning rate of 0.001 which is reduced by 0.1 once learning stagnates. The default batch size is 128 and the default maximum number of epochs is 100 without early stopping.

FIG. 3D illustrates an example view 300D of the encoder 340 and the decoder 350 according to examples and features of the instant solution. Referring to FIG. 3D, the encoder 340 includes a plurality of layers including arrays 41, 42, 43, and 44, batch normalization layers 51, 52, and 53, rectified linear units (ReLUs) 61, 62, and 63, and drop-out layers 71 and 72. The encoder 340 takes the meta-features obtained during the feature extraction step as input and generates embedded features, which are stored in an array 45. Meanwhile, the decoder 350 takes the embedded features from the array 45, and reconstructs the meta-features. Here, the decoder 350 also includes a plurality of layers including arrays 46, 47, 48, and 49, batch normalization layers 54, 55, and 56, ReLUs 64, 65, and 66, and drop-out layers 73 and 74. The number of features decrease while advancing through the layers of the encoder 340. For example, the default number of input features in the first layer of the encoder 340 is a first number, the default number of output features in the first layer of the encoder 340 is a second number smaller than the first number, the default number of input features in the second layer of the encoder 340 is a third number smaller than the second number, the default number of output features in the second layer of the encoder 340 is a fourth number that is smaller than the third number, the default number of output features in a third layer of the encoder 340 is a fifth number that is smaller than the fourth number, and the default number of output features in a fourth layer of the encoder 350 is a sixth number that is smaller than the fifth number. In at least some embodiments, a dropout ratio of 0.2 is used and a prediction head is used which contains only a linear layer.

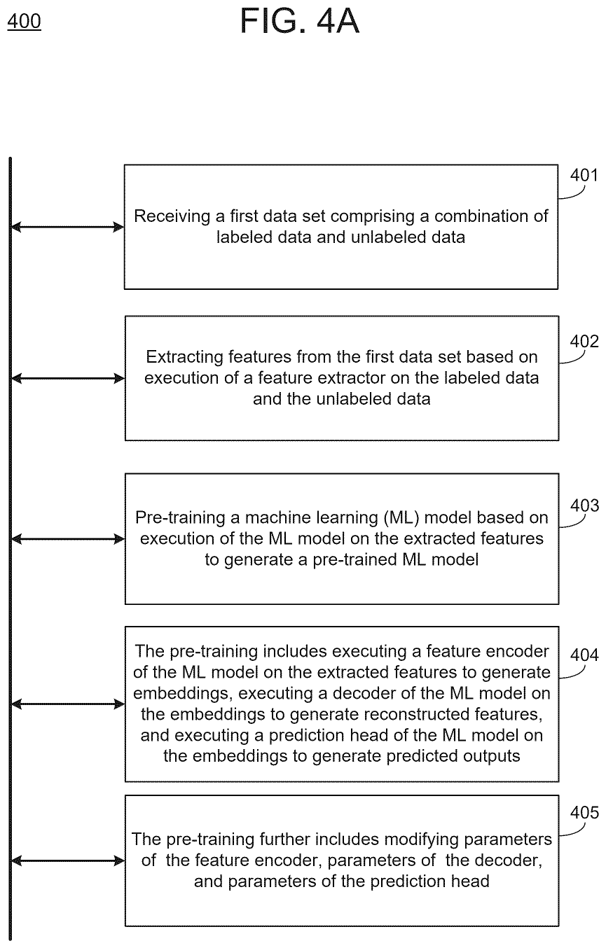

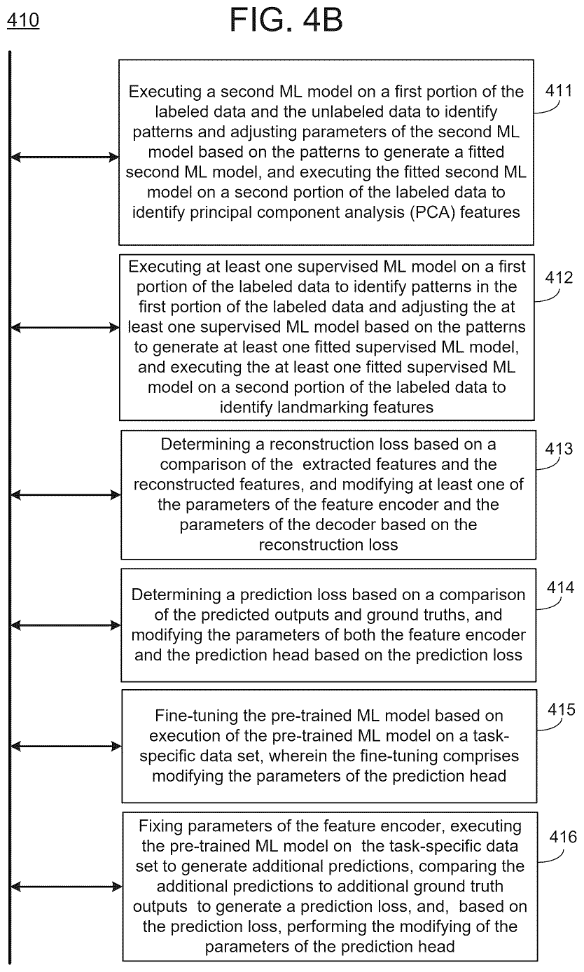

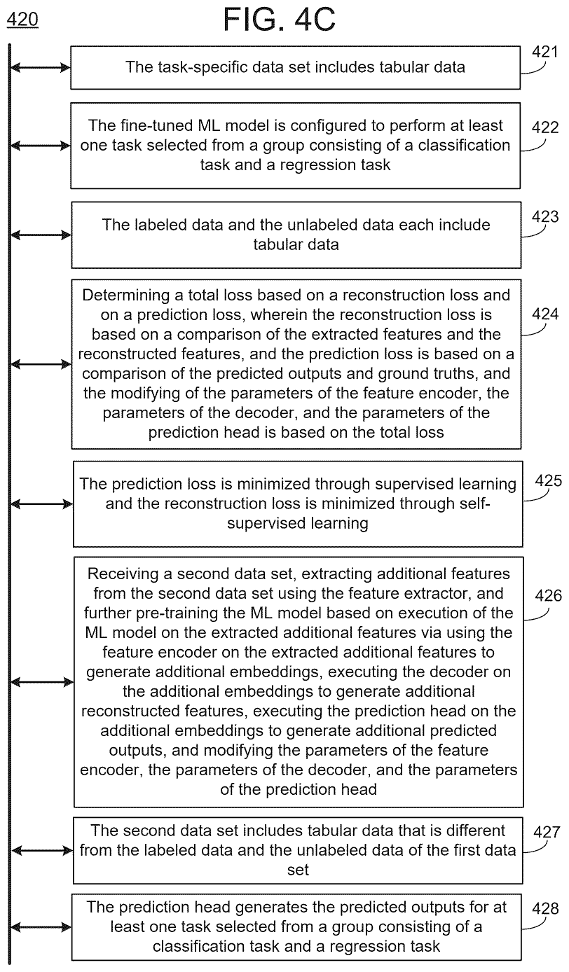

FIG. 4A illustrates a flow diagram of a method 400, according to example embodiments. Referring to FIG. 4A, in 401, the method may include receiving a first data set comprising a combination of labeled data and unlabeled data. In 402, the method may include extracting features from the first data set based on execution of a feature extractor on the labeled data and the unlabeled data. In 403, the method may include pre-training a machine learning (ML) model based on execution of the ML model on the extracted features to generate a pre-trained ML model. In 404, the method may include executing a feature encoder of the ML model on the extracted features to generate embeddings, executing a decoder of the ML model on the embeddings to generate reconstructed features, and executing a prediction head of the ML model on the embeddings to generate predicted outputs. In 405, the method may include modifying parameters of the feature encoder, parameters of the decoder, and parameters of the prediction head.

FIG. 4B illustrates a flow diagram of a method 410, according to example embodiments. Referring to FIG. 4B, in 411, the method may include executing a second ML model on a first portion of the labeled data and the unlabeled data to identify patterns and adjusting parameters of the second ML model based on the patterns to generate a fitted second ML model, and executing the fitted second ML model on a second portion of the labeled data to identify principal component analysis (PCA) features. In 412, the method may include executing at least one supervised ML model on a first portion of the labeled data to identify patterns in the first portion of the labeled data and adjusting the at least one supervised ML model based on the patterns to generate at least one fitted supervised ML model, and executing the at least one fitted supervised ML model on a second portion of the labeled data to identify landmarking features.

In 413, the method may include determining a reconstruction loss based on a comparison of the extracted features and the reconstructed features, and modifying at least one of the parameters of the feature encoder and the parameters of the decoder based on the reconstruction loss. In 414, the method may include determining a prediction loss based on a comparison of the predicted outputs and ground truths, and modifying the parameters of both the feature encoder and the prediction head based on the prediction loss.

In 415, the method may include fine-tuning the pre-trained ML model based on execution of the pre-trained ML model on a task-specific data set, wherein the fine-tuning includes modifying the parameters of the prediction head. In 416, the fine-tuning may further include fixing parameters of the feature encoder, executing the pre-trained ML model on the task-specific data set to generate additional predictions, comparing the additional predictions to additional ground truth outputs to generate a prediction loss, and, based on the prediction loss, performing the modifying of the parameters of the prediction head.

FIG. 4C illustrates a flow diagram of another method 420 according to additional examples and features of the instant solution. Referring to FIG. 4C, in 421, the task-specific data set includes tabular data. In 422, the fine-tuned ML model is configured to perform at least one task selected from a group consisting of a classification task and a regression task. In 423, the labeled data and the unlabeled data each include tabular data. In 424, the method may include determining a total loss based on a reconstruction loss and on a prediction loss, wherein the reconstruction loss is based on a comparison of the extracted features and the reconstructed features, wherein the prediction loss is based on a comparison of the predicted outputs and ground truths, and wherein the modifying of the parameters of the feature encoder, the parameters of the decoder, and the parameters of the prediction head is based on the total loss. In 425, the prediction loss is minimized through supervised learning and the reconstruction loss is minimized through self-supervised learning.

In 426, the method may include receiving a second data set, extracting additional features from the second data set using the feature extractor, and further pre-training the ML model based on execution of the ML model on the extracted additional features via: using the feature encoder on the extracted additional features to generate additional embeddings, executing the decoder on the additional embeddings to generate additional reconstructed features, executing the prediction head on the additional embeddings to generate additional predicted outputs, and modifying the parameters of the feature encoder, the parameters of the decoder, and the parameters of the prediction head.

In 427, the second data set includes tabular data that is different from the labeled data and the unlabeled data of the first data set. In 428, the prediction head generates the predicted outputs for at least one task selected from a group consisting of a classification task and a regression task.

Detailed descriptions of training a machine learning model and executing a machine learning model are further described and depicted herein.

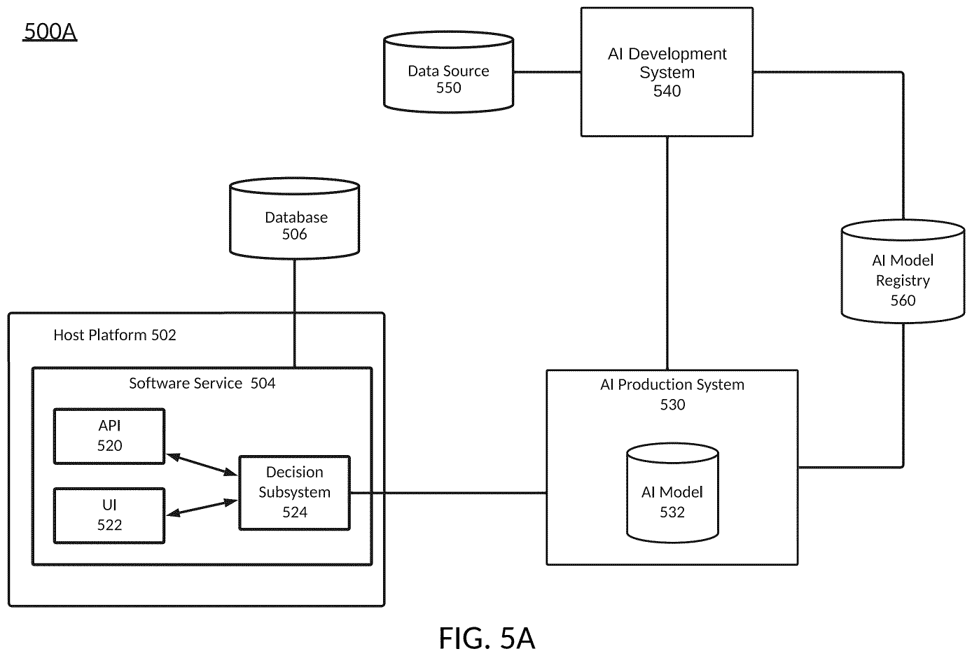

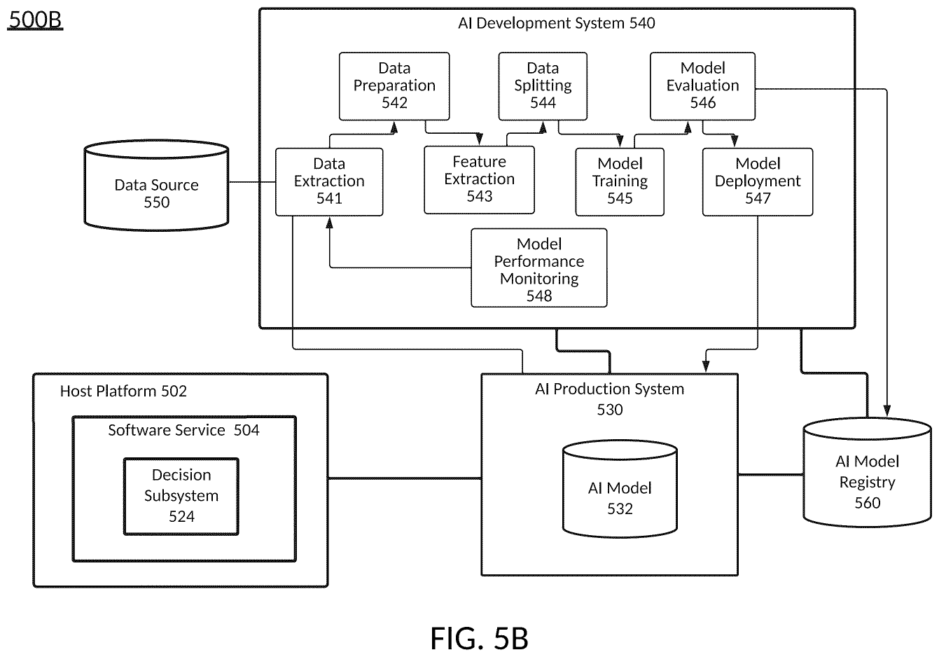

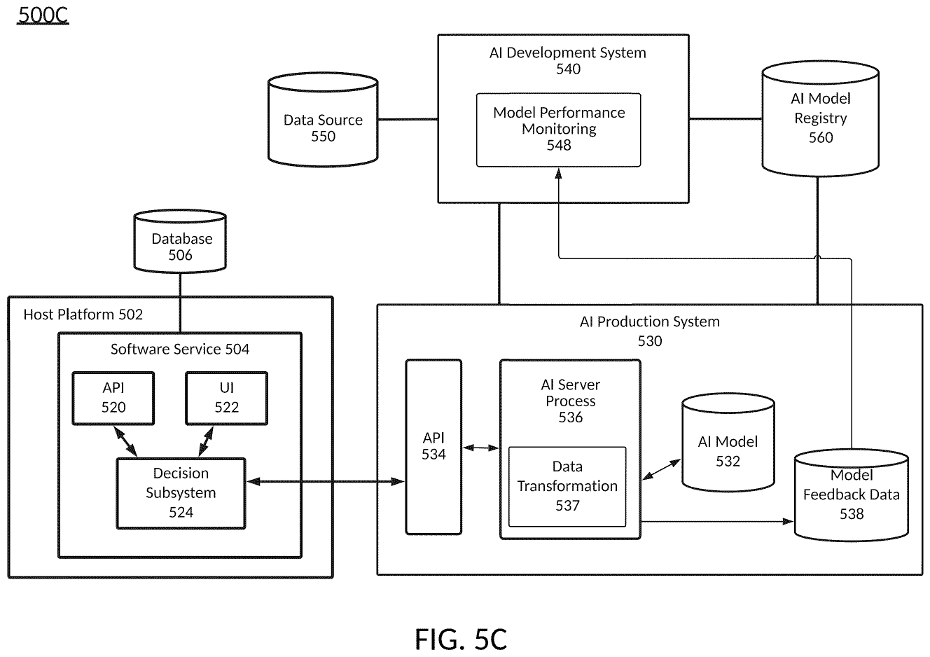

FIG. 5A illustrates an artificial intelligence (AI) network diagram 500A that supports AI-assisted decision points in a software service executing on a computer. As one example, the AI model being trained in the examples herein may refer to an AI model for any of the tasks performed herein including a machine learning model, a neural network, a large language model (LLM), and the like. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities rely on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Artificial intelligence systems have been built and trained to perform various tasks in an automated manner. For example, artificial intelligence systems receive and understand verbal and/or written dialogue and function as digital assistants, speech-to-text programs, etc. Other artificial intelligence systems are trained on different types of information to allow the trained system to generate content—such as new works of art based on the styles seen, or new compound ideas based on the history of chemical research.

Foundation models are types of artificial intelligence systems that are trained on a broad set of unlabeled data that can be used for different tasks, with minimal fine-tuning. The unlabeled data includes in some instances imagery and/or language. In response to a short prompt being input into the foundation model, the system generates an output such as an entire essay, or a complex image, based on the parameters that are set forth in the input prompt. The foundation model is able to produce an output that attempts to meet the parameters even if the foundation model was never trained with specific training data that included the exact parameters, e.g., was never trained for that exact argument or to generate an image in that way.

Using self-supervised learning and transfer learning, foundation models can apply information that they have learnt about one situation to another. For example, like a human learns how to drive on one car, for example, and without too much effort, could learn how to drive other types of vehicles such as other cars, a truck, or a bus. The foundation model similarly is used to achieve proficiency in some new area without having to be trained completely from scratch. Foundation models seem to have inherent creativity in performing tasks such as stringing together coherent arguments or creating entirely original pieces of art. Foundation models are established in the technology of natural-language processing. One example of how foundation models are helpful is that for previous generation of AI techniques, if you wanted to build an AI model that could summarize bodies of text for you, you would need tens of thousands of labeled examples just for the summarization use case. With a pre-trained foundation model, the labeled data requirements are dramatically reduced. First, the foundation model is fine-tuned with a domain-specific unlabeled corpus to create a domain-specific foundation model. Then, using a much smaller amount of labeled data, potentially just a thousand labeled examples, a foundation model is trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using as little as a few thousand sentences—100 times fewer annotations required than previous models. Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

Large language models (LLMs) are a category of foundation models trained on immense amounts of data making them capable of understanding and generating natural language and other types of content to perform a wide range of tasks. LLMs have been implemented at different levels to enhance their natural language understanding (NLU) and natural language processing (NLP) capabilities. This advancement of LLMs has occurred alongside advances in machine learning, machine learning models, algorithms, neural networks and the transformer models that provide the architecture for these AI systems.

LLMs are a class of foundation models, which are trained on enormous amounts of data to provide the foundational capabilities needed to drive multiple use cases and applications, as well as resolve a multitude of tasks. This LLM concept is in stark contrast to the idea of building and training domain specific models for each of these use cases individually, which is prohibitive under many criteria (most importantly cost and infrastructure), stifles synergies and can even lead to inferior performance.

LLMs represent a significant breakthrough in NLP and artificial intelligence. LLMs are accessible through interfaces like Open AI's Chat GPT-3 and GPT-4, which have garnered the support of Microsoft. Other examples include Meta's Llama models and Google's bidirectional encoder representations from transformers (BERT/RoBERTa) and PaLM models. IBM has also recently launched its Granite model series on watsonx.ai, which has become the generative AI backbone for other IBM products like watsonx Assistant and watsonx Orchestrate.

In a nutshell, LLMs are designed to understand and generate text like a human, in addition to other forms of content, based on the vast amount of data used to train them. They have the ability to infer from context, generate coherent and contextually relevant responses, translate to languages other than English, summarize text, answer questions (general conversation and FAQs) and even assist in creative writing or code generation tasks. LLMs are able to do some or all of these tasks thanks to many, e.g., billions of, parameters that enable them to capture intricate patterns in language and perform a wide array of language-related tasks. LLMs are revolutionizing applications in various fields, from chatbots and virtual assistants to content generation, research assistance and language translation.

LLMs operate by leveraging deep learning techniques and vast amounts of textual data. These models are typically based on a transformer architecture, like the generative pre-trained transformer, which excels at handling sequential data like text input. LLMs consist of multiple layers of neural networks, each with parameters that can be fine-tuned during training, which are enhanced further by a numerous layer known as the attention mechanism, which dials in on specific parts of data sets.

During the training process, these models learn to predict the next word in a sentence based on the context provided by the preceding words. The model does this through attributing a probability score to the recurrence of words that have been tokenized—broken down into smaller sequences of characters. These tokens are then transformed into embeddings, which are numeric representations of this context.

To ensure accuracy, this process involves training the LLM on a large corpus of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive, and drawing on the patterns and knowledge they have acquired. The result is coherent and contextually relevant language generation that can be harnessed for a wide range of NLU and content generation tasks.

Model performance can also be increased through prompt engineering, prompt-tuning, fine-tuning and other tactics like reinforcement learning with human feedback (RLHF) to remove the biases, hateful speech and factually incorrect answers known as “hallucinations” that are often unwanted byproducts of training on so much unstructured data. LLMs augment conversational AI in chatbots and virtual assistants to enhance the interactions that provide context-aware responses that mimic interactions with human agents.

LLMs also excel in content generation, automating content creation for blog articles, explanatory materials, and other writing tasks. LLMs aid in summarizing and extracting information from vast datasets, accelerating knowledge discovery. LLMs also play a vital role in language translation, breaking down language barriers by providing accurate and contextually relevant translations. LLMs can even be used to write code, or “translate” between programming languages. LLMs contribute to accessibility by assisting individuals with disabilities, including text-to-speech applications and generating content in accessible formats.

LLMs often include abilities such as:
Text generation: language generation abilities, such as writing emails, blog posts or other mid-to-long form content in response to prompts that can be refined and polished. An excellent example is retrieval-augmented generation (RAG).
Content summarization: summarize long articles, news stories, research reports, corporate documentation and even interaction history into thorough texts tailored in length to the output format.
AI assistants: chatbots that answer queries, perform backend tasks and provide detailed information in natural language as a part of an integrated, self-serve solution for handling inquiries.
Code generation: assists developers in building applications, finding errors in code and uncovering security issues in multiple programming languages, even “translating” between them.
Sentiment analysis: analyze text to determine a user's tone in order to understand user feedback at scale and aid in brand reputation management.
Language translation: provides wider coverage to organizations across languages and geographies with fluent translations and multilingual capabilities.

Software service 504 (see FIG. 5A), executing on host platform 502 (see FIG. 5A) may provide one or more application programming interfaces (APIs) 520 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 520 send data to one or more decision subsystems 524 of the software service 504 to assist in decision-making. In some examples and features of the instant solution, the software service 504 stores data included in API requests or data generated during processing the API requests into one or more databases 506 (see FIG. 5A).

Software service 504 may provide one or more user interfaces (UIs) 522, such as a server-side hosted graphical user interface (GUI). In some examples and features of the instant solution, the UIs 522 provided employ template-based frameworks, component-based frameworks, etc. In some examples and features of the instant solution, these UIs 522 send data to one or more decision subsystems 524 of the software service 504 to assist with decision-making. In some examples and features of the instant solution, the software service 504 stores data included in UI requests or data generated during processing the UI requests into one or more databases 506.

Software service 504 may include one or more decision subsystems 524 that drive a decision-making process of the software service 504. In some examples and features of the instant solution, the decision subsystems 524 receive data from one or more APIs 520 as input into the decision-making process. In some examples and features of the instant solution, a decision subsystem 524 may receive data from one or more UIs 522 as input to the decision-making process. A decision subsystem 524 may gather service configuration or historical execution data from one or more databases 506 to aid in the decision-making process. A decision subsystem 524 may provide feedback to an API 520 or a UI 522.

An AI production system 530 may be used by a decision subsystem 524 in a software service 504 to assist in its decision-making process. The AI production system 530 includes one or more AI models 532 that are executed to generate a response, such as, but not limited to, a prediction, a categorization, a UI prompt, etc. In some examples and features of the instant solution, an AI production system 530 is hosted on a server. In some examples and features of the instant solution, the AI production system 530 is cloud-hosted. In some examples and features of the instant solution, the AI production system 530 is deployed in a distributed multi-node architecture.

An AI development system 540 creates one or more AI models 532. In some examples and features of the instant solution, the AI development system 540 utilizes data from one or more data sources 550 to develop and train one or more AI models 532. The data sources 550 may be local or third-party data sources. Further, the data provided by the data sources may be real-world or synthetic. In some examples and features of the instant solution, the AI development system 540 utilizes feedback data from one or more AI production systems 530 for new model development and/or existing model re-training. In some examples and features of the instant solution, the AI development system 540 resides and executes on a server. In some examples and features of the instant solution, the AI development system 540 is cloud hosted. In some examples and features of the instant solution, the AI development system 540 is deployed in a distributed multi-node architecture. In some examples and features of the instant solution, the AI development system 540 utilizes a distributed data pipeline/analytics engine.

Once an AI model 532 has been trained and validated in the AI development system 540, it may be stored in an AI model registry 560 for retrieval by either the AI development system 540 or by one or more AI production systems 530. The AI model registry 560 resides in a dedicated server in one example of the instant solution. In some examples and features of the instant solution, the AI model registry 560 is cloud-hosted. In some examples and features of the instant solution, the AI model registry 560 resides in the AI production system 530. In some examples and features of the instant solution, the AI model registry 560 is a distributed database.

FIG. 5B illustrates a process 500B for developing one or more AI models that support AI-assisted decision points. An AI development system 540 executes steps to develop an AI model 532 that begins with data extraction 541, in which data is loaded and ingested from one or more data sources 550. In some examples and features of the instant solution, historical model feedback data is extracted from one or more AI production systems 530.

Once the data has been extracted during data extraction 541, it undergoes data preparation 542 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 542 may be a manual process or an automated process using one or more of the elements and/or functions described and/or depicted herein.

Features of the data are identified and extracted during the feature extraction step 543. In some examples and features of the instant solution, a feature of the data is internal to the prepared data from the data preparation step 542. In some examples and features of the instant solution, a feature of the data requires a piece of prepared data from the data preparation step 542 to be enriched by data from another data source to be useful in developing the AI model 532. In some examples and features of the instant solution, identifying relevant features (relevant attributes) for model training are performed via an automated process using one or more of the elements and/or functions described and/or depicted herein. Once the features have been identified, the values of the features are collected into a dataset that will be used to develop the AI model 532.

The dataset output from the feature extraction step 543 is split 544 into a training and validation data set. The training data set is used to train the AI model 532, and the validation data set is used to evaluate the performance of the AI model 532 on unseen data.

The AI model 532 is trained and tuned 545 using the training data set from the data splitting step 544. In this step, the training data set is provided to an AI algorithm and an initial set of algorithm parameters which may be automatically determined based on the interdependence between the relevant attributes determined according to various embodiments. The performance of the AI model 532 is then tested within the AI development system 540 utilizing the validation data set from step 544. These steps may be repeated with adjustments to one or more algorithm parameters until the model's performance is acceptable based on various goals and/or results.

The AI model 532 is evaluated 546 in a staging environment (not shown) that resembles the target AI production system 530. This evaluation uses a validation dataset to ensure the performance in an AI production system 530 matches or exceeds expectations. In some examples and features of the instant solution, the validation dataset from step 544 is used. In some examples and features of the instant solution, one or more unseen validation datasets are used. In some examples and features of the instant solution, the staging environment is part of the AI development system 540, and the staging environment is managed separately from the AI development system 540. Once the AI model 532 has been validated, it is stored in an AI model registry 560, where it can be retrieved for deployment and future updates. In some examples and features of the instant solution, the model evaluation step 546 may be a manual process or an automated process using one or more of the elements and/or functions described and/or depicted herein.

In some examples and features of the instant solution, the AI development system includes a user interface (not shown). The user interface may be used to manage the development system infrastructure, the steps 541-548 within the development system, the interim data transmitted between the various steps 541-548, and the data sources 550.

Once an AI model 532 has been validated and published to an AI model registry 560, it may be deployed during the model deployment step 547 to one or more AI production systems 530. In some examples and features of the instant solution, the performance of deployed AI model 532 is monitored 548 by the AI development system 540. In some examples and features of the instant solution, AI model 532 feedback data is provided by the AI production system 530 to enable model performance monitoring 548, and the AI development system 540 periodically requests feedback data for model performance monitoring 548, which includes one or more triggers that result in the AI model 532 being updated by repeating steps 541-548 with updated data from one or more data sources 550.

FIG. 5C illustrates a process 500C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 5C, an AI production system 530 may be used by a decision subsystem 524 in software service 504 to assist in its decision-making process. The AI production system 530 provides an API 534, executed by an AI server process 536 through which requests can be made. In some examples and features of the instant solution, a request may include an AI model 532 identifier to be executed based on the type of request. In some examples and features of the instant solution, a data payload (e.g., to be input to the AI model during execution) is included in the request. The data payload may include API 520 data from software service 504, UI 522 data from software service 504 or data from other software service 504 subsystems (not shown).

Upon receiving the API 534 request, the AI server process 536 may transform 537 the data payload or portions of the data payload to be valid feature values in an AI model 532. Data transformation 537 may include, but is not limited to, combining data values, normalizing data values, and enriching the incoming data with data from other data sources 550. Once the data transformation occurs, the AI server process 536 executes the appropriate AI model 532 using the transformed input data. Upon receiving the execution result, the AI server process 536 responds to the API requester, which is a decision subsystem 524 of software service 504. In some examples and features of the instant solution, the response may result in an update to a UI 522 in software service 504. In some examples and features of the instant solution, the response includes a request identifier that can be used later by the software service 504 to provide feedback on the performance of the AI model 532. In some examples and features of the instant solution, a model feedback record may be added into a model feedback data 538 by the AI server process 536.

In some examples and features of the instant solution, the API 534 includes an interface to provide AI model 532 feedback after an AI model 532 execution response has been processed. This mechanism enables the requester to provide feedback on the accuracy of the AI model 532 results. In some examples and features of the instant solution, the feedback interface includes the identifier of the initial request so that it can be used to associate the feedback with the request. Upon receiving a call into the feedback interface of the API 534, the AI server process 536 creates and adds a model feedback record into the model feedback data 538 which holds historical model feedback records. In some examples and features of the instant solution, the records in this model feedback data 538 are provided to model performance monitoring 548 in the AI development system 540. This model feedback data is streamed to the AI development system 540 or may be provided upon request. In some examples and features of the instant solution, the model feedback records in the model feedback data 538 are used as an input for retraining the AI model 532.

In some examples and features of the instant solution, the AI production system 530 includes a user interface (not shown). The user interface may be used to manage the production system infrastructure, the components of the production system 530-538, and the operation of the AI production system and its components.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A method comprising:
receiving a first data set comprising a combination of labeled data and unlabeled data;
extracting features from the first data set based on execution of a feature extractor on the labeled data and the unlabeled data; and
pre-training a machine learning (ML) model based on execution of the ML model on the extracted features to generate a pre-trained ML model,
wherein the pre-training comprises executing a feature encoder of the ML model on the extracted features to generate embeddings, executing a decoder of the ML model on the embeddings to generate reconstructed features, and executing a prediction head of the ML model on the embeddings to generate predicted outputs, and
wherein the pre-training further comprises modifying parameters of the feature encoder, parameters of the decoder, and parameters of the prediction head.

2. The method of claim 1, wherein the extracting comprises executing a second ML model on a first portion of the labeled data and the unlabeled data to identify patterns and adjusting parameters of the second ML model based on the patterns to generate a fitted second ML model, and executing the fitted second ML model on a second portion of the labeled data to identify principal component analysis (PCA) features.

3. The method of claim 1, wherein the extracting comprises executing at least one supervised ML model on a first portion of the labeled data to identify patterns in the first portion of the labeled data and adjusting the at least one supervised ML model based on the patterns to generate at least one fitted supervised ML model, and executing the at least one fitted supervised ML model on a second portion of the labeled data to identify landmarking features.

4. The method of claim 1, wherein the pre-training further comprises determining a reconstruction loss based on a comparison of the extracted features and the reconstructed features, and modifying at least one of the parameters of the feature encoder and the parameters of the decoder based on the reconstruction loss.

5. The method of claim 1, wherein the pre-training further comprises determining a prediction loss based on a comparison of the predicted outputs and ground truths, and modifying the parameters of both the feature encoder and the prediction head based on the prediction loss.

6. The method of claim 1, further comprising fine-tuning the pre-trained ML model based on execution of the pre-trained ML model on a task-specific data set, wherein the fine-tuning comprises modifying the parameters of the prediction head.

7. The method of claim 6, wherein the fine-tuning further comprises fixing parameters of the feature encoder, executing the pre-trained ML model on the task-specific data set to generate additional predictions, comparing the additional predictions to additional ground truth outputs to generate a prediction loss, and, based on the prediction loss, performing the modifying of the parameters of the prediction head.

8. The method of claim 6, wherein the task-specific data set comprises tabular data.

9. The method of claim 6, wherein the fine-tuned ML model is configured to perform at least one task selected from a group consisting of a classification task and a regression task.

10. The method of claim 1, wherein the labeled data and the unlabeled data each include tabular data.

11. The method of claim 1, wherein the pre-training further comprises determining a total loss based on a reconstruction loss and on a prediction loss, wherein the reconstruction loss is based on a comparison of the extracted features and the reconstructed features, wherein the prediction loss is based on a comparison of the predicted outputs and ground truths, and wherein the modifying of the parameters of the feature encoder, the parameters of the decoder, and the parameters of the prediction head is based on the total loss.

12. The method of claim 11, wherein the prediction loss is minimized through supervised learning and the reconstruction loss is minimized through self-supervised learning.

13. The method of claim 1, further comprising:
receiving a second data set;
extracting additional features from the second data set using the feature extractor; and
further pre-training the ML model based on execution of the ML model on the extracted additional features via:
using the feature encoder on the extracted additional features to generate additional embeddings;
executing the decoder on the additional embeddings to generate additional reconstructed features;
executing the prediction head on the additional embeddings to generate additional predicted outputs; and
modifying the parameters of the feature encoder, the parameters of the decoder, and the parameters of the prediction head.

14. The method of claim 13, wherein the second data set comprises tabular data that is different from the labeled data and the unlabeled data of the first data set.

15. The method of claim 1, wherein the prediction head generates the predicted outputs for at least one task selected from a group consisting of a classification task and a regression task.

16. A computer system comprising:
a processor set;
one or more computer readable storage media; and
program instructions stored on the one or more computer readable storage media to cause the processor set to perform operations comprising:
receiving a first data set comprising a combination of labeled data and unlabeled data;
extracting features from the first data set based on execution of a feature extractor on the labeled data and the unlabeled data; and
pre-training a machine learning (ML) model based on execution of the ML model on the extracted features to generate a pre-trained ML model,
wherein the pre-training comprises executing a feature encoder of the ML model on the extracted features to generate embeddings, executing a decoder of the ML model on the embeddings to generate reconstructed features, and executing a prediction head of the ML model on the embeddings to generate predicted outputs, and
wherein the pre-training further comprises modifying parameters of the feature encoder, parameters of the decoder, and parameters of the prediction head.

17. The computer system of claim 8, wherein the extracting comprises executing a second ML model on a first portion of the labeled data and the unlabeled data to identify patterns and adjusting parameters of the second ML model based on the patterns to generate a fitted second ML model, and executing the fitted second ML model on a second portion of the labeled data to identify principal component analysis (PCA) features.

18. The computer system of claim 1, wherein the pre-training further comprises determining a reconstruction loss based on a comparison of the extracted features and the reconstructed features, and modifying at least one of the parameters of the feature encoder and the parameters of the decoder based on the reconstruction loss.

19. A computer program product comprising:
one or more computer-readable storage media; and
program instructions stored on the one or more computer-readable storage media to perform operations comprising:
receiving a first data set comprising a combination of labeled data and unlabeled data;
extracting features from the first data set based on execution of a feature extractor on the labeled data and the unlabeled data; and
pre-training a machine learning (ML) model based on execution of the ML model on the extracted features to generate a pre-trained ML model,
wherein the pre-training comprises executing a feature encoder of the ML model on the extracted features to generate embeddings, executing a decoder of the ML model on the embeddings to generate reconstructed features, and executing a prediction head of the ML model on the embeddings to generate predicted outputs, and
wherein the pre-training further comprises modifying parameters of the feature encoder, parameters of the decoder, and parameters of the prediction head.

20. The computer program product of claim 19, wherein the pre-training further comprises determining a reconstruction loss based on a comparison of the extracted features and the reconstructed features, and modifying at least one of the parameters of the feature encoder and the parameters of the decoder based on the reconstruction loss.
